(19) United States
(12) Patent Application Publication
(10) Pub. No.: US 2025/0130431 A1
(43) Pub. Date: Apr. 24, 2025

(54) PIXEL ALIGNMENT FOR BINOCULAR DISPLAY SYSTEMS

(71) Applicant: GOOGLE LLC, Mountain View, CA (US)

(72) Inventor: Daniel Adema, Kitchener (CA)

(21) Appl. No.: 18/919,125

(22) Filed: Oct. 17, 2024

Related U.S. Application Data
(60) Provisional application No. 63/591,864, filed on Oct. 20, 2023.

(51) Int. Cl. G02B 27/01

(52) U.S. Cl. CPC G02B 27/0176; G02B 27/0172; G02B 2027/0132; G02B 2027/0159; G02B 2027/0178

(57) ABSTRACT

According to an aspect, a system includes a first image source for a left eye and a second image source for a right eye. The system further includes at least one window in a first optical path for the first image source or a second optical path for the second image source, the at least one window configured to align first pixels from the first image source with second pixels from the second image source.

### CROSS-REFERENCE TO RELATED APPLICATION

This application claims priority to U.S. Provisional Patent Application No. 63/591,864, filed on Oct. 20, 2023, entitled “SUB-PIXEL PITCH OPTICAL ALIGNMENT SYSTEM FOR BINOCULAR AR/VR DISPLAY SYSTEMS,” the disclosure of which is incorporated by reference herein in its entirety.

### BACKGROUND

Extended Reality (XR) displays, which include virtual reality (VR), augmented reality (AR), and mixed reality (MR) devices, work by creating immersive or augmented environments through high-resolution screens or projections. These displays can use Organic Light Emitting Diode (OLED), Micro Light Emitting Diode (microLED), Liquid Crystal Display (LCD), or another display technology housed inside headsets or smart glasses to project images directly into the user's field of view. In VR, the display fully immerses the user in a digital environment by covering the visual field with three-dimensional content. In AR, the display overlays digital information onto the physical world through transparent or semi-transparent lenses. XR displays rely on sensors like cameras, gyroscopes, and accelerometers to track head movement, adjust the view dynamically, and provide a seamless, interactive experience.

### SUMMARY

This disclosure relates to systems and methods for providing pixel alignment in binocular display systems. In at least one implementation, an extended reality (XR) computing device includes a binocular display system. A binocular display system can present separate images to each eye using two screens or lenses, creating a stereoscopic three-dimensional effect. This system simulates depth perception by mimicking how human eyes naturally view objects from slightly different angles. To support the proper alignment of the right and left eye displays, an adjustable window is placed in the optical path of at least one of the displays to align the pixels. In at least one example, the system projects first images for the left eye and second images for the right eye using a first image source and a second image source, respectively. The system includes at least one window in the optical path for the first image source and/or the second image source to align the pixels for the right and the left eye.

In some aspects, the techniques described herein relate to a system including: a first image source for a left eye; a second image source for a right eye; and at least one window in a first optical path for the first image source or a second optical path for the second image source, the at least one window configured to align first pixels from the first image source with second pixels from the second image source as part of a binocular display.

In some aspects, the techniques described herein relate to a method including: identifying an error in alignment between a first image source and a second image source, the first image source and the second image source configured to provide a binocular display on a computing device; determining at least one angle for at least one window in a first optical path for the first image source or a second optical path for the second image source to correct the error; and configuring the at least one window on the computing device with the at least one angle.

In some aspects, the techniques described herein relate to a computer-readable storage medium having program instructions stored thereon that, when executed by at least one processor, direct the at least one processor to perform a method, the method including: identifying an error in alignment between a first image source and a second image source, the first image source and second image source configured to provide a binocular display on a computing device; determining at least one angle for at least one window in a first optical path for the first image source or a second optical path for the second image source to correct the error; and configuring the at least one window on the computing device with the at least one angle.

The accompanying drawings and the description below set forth the details of one or more implementations. Other features will be apparent from the description, drawings, and claims.

### BRIEF DESCRIPTION OF THE DRAWINGS

FIG. 1 illustrates an extended reality (XR) computing device according to an implementation.

FIG. 2 illustrates an optical overview for an XR computing device according to an implementation.

FIG. 3 illustrates a method of updating an optical configuration for a device according to an implementation.

FIG. 4 illustrates an optical configuration for an XR computing device according to an implementation.

FIG. 5 illustrates an optical configuration for an XR computing device according to an implementation.

FIG. 6 illustrates an XR computing device according to an implementation.

### DETAILED DESCRIPTION

This disclosure relates to systems and methods for providing pixel alignment in binocular display systems. A binocular display system in an XR device, such as a VR or AR headset, is designed to present two slightly different images, one for each eye, to create a stereoscopic three-dimensional effect. This system replicates how human eyes perceive depth by taking advantage of binocular vision, where each eye views the world from a slightly different angle. In an XR device, the images displayed to each eye are calculated to mimic this disparity, making the virtual or augmented environment appear three-dimensional and lifelike. The system can use high-resolution OLEDs or LCDs combined with lenses that help focus and converge the light from the display screens into the correct position for the user's eyes.

As at least one technical problem with binocular display systems, pixel alignment and image synchronization are crucial to maintaining a coherent three-dimensional experience. Misalignment of pixels between the two eyes can lead to discomfort, eye strain, and a loss of depth perception. For example, in a VR headset, the entire visual field is virtual, meaning the depth and placement of virtual objects must align precisely between the two eyes. In AR devices, the binocular system must also account for the real-world scene and overlay digital information accurately. This requires the device to not only align virtual content across the eyes but also align it with the user's view of the real world. The result is an immersive or augmented experience where objects appear to exist in the user's real or virtual environment, enhancing the sense of presence and interaction in XR applications.

In at least one technical solution, to assist in aligning pixels displayed for the left eye with pixels displayed for the right eye, at least one window is introduced in the optical path of the image source for the right eye or the image source for the left eye. In at least one implementation, an XR device includes a first image source for the user's left eye and a second image source for the user's right eye. These image sources can use light sources, like microLED or laser-based systems, to project virtual content directly onto the device's lenses, which can act as both a display surface and a lens through which users view the real world. The images are combined with the user's natural vision of the physical environment, overlaying digital information or three-dimensional objects in the physical space. This setup creates an augmented view, allowing users to interact with real-world and virtual elements simultaneously. Pixels for the image sources must be aligned to make a desirable setup for the user. Alignment refers to the precise positioning and synchronization of the images presented to each eye so that they work together to create a seamless three-dimensional effect. For a stereoscopic experience, the images shown to the left and right eye must correspond accurately to how human vision naturally perceives depth and perspective. Alignment involves pixel alignment, convergence, and geometric alignment. For pixel alignment, each pixel in the image for the left eye must match the corresponding pixel in the image for the right eye, allowing both images to converge properly when viewed together.

In at least one technical solution, when the image sources are produced for the computing device, the pixels from the image sources may deviate from the required alignment. In some examples, a window is added to the optical path of the first image source to correct the alignment. The optical path for the image source is the route that light travels from the image source, including lenses, mirrors, or other optics. The window can shift light by refracting it when the light passes through at an angle, causing a change in its direction. The amount of shift depends on the material's refractive index and the angle at which the light enters. For example, to correct the alignment of an image source in a binocular display for an XR device, a window can be placed in the optical path of the image source at an angle, such that light is shifted to place the image sources in alignment. As a technical effect, if the light from the right eye image source is too low in reference to the left eye, the angle of the window can be used to shift the light (or pixels) to place the light in alignment with the left eye image source.

In at least one technical solution, the device can use multiple windows to support the shift of light and pixel alignment. In some implementations, the device can be configured with a first window in the optical path for a first image source to correct alignment around a first axis (e.g., image source for the left eye). The device can further be configured with a second window in the optical path for a second image source to correct alignment around a second axis (e.g., image source for the right eye). For example, the first window for the first image source can be used to correct the alignment vertically between the two image sources, while the second window for the second image source can be used to correct the alignment horizontally. In this example, multiple windows can be used to correct the alignment. However, in some implementations, a single window can correct the alignment across multiple axes (i.e., vertical and horizontal). This can require actuators or other system capable of positioning the window at the desired angle.

In some implementations, when an XR device is being manufactured, tests can be used to determine the alignment of the image sources on the device. From the testing, the at least one window can be configured or adjusted to correct any alignment errors identified from the testing. In some examples, the testing is measured by testing the projections from the device to identify potential misalignment associated with the pixels using cameras or other sensors. Misalignment can be determined from distortions or offsets in the image. In some implementations, the misalignment can be determined based on visual inspection or measurements of the image sources on the device itself (e.g., variances in the device's construction). The identified alignment errors can be used to identify at least one angle for at least one window on the device to correct the alignment of the images from the image sources. As a technical effect, windows can be updated for the devices after manufacturing to correct alignment issues incurred during manufacturing.

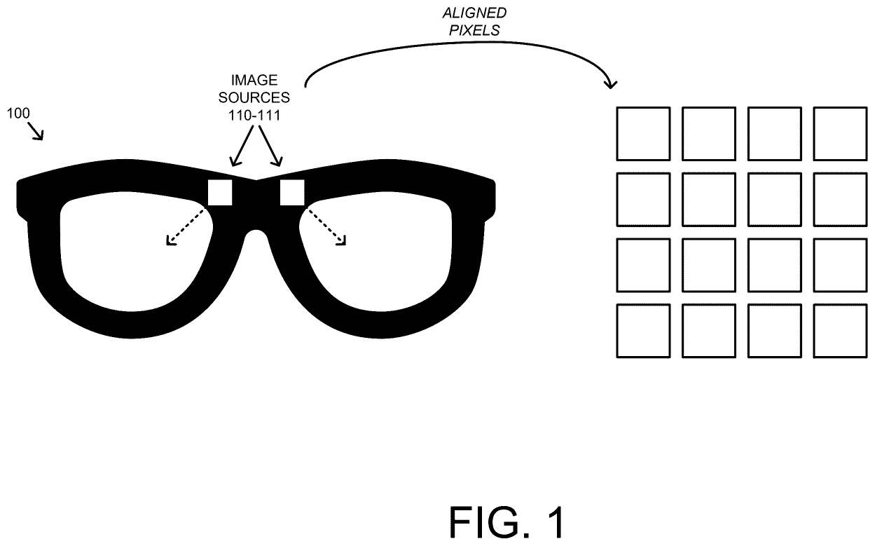

FIG. 1 illustrates an XR computing device 100 according to an implementation. XR computing device 100 includes image source 110 and image source 111. An expanded example of image source 111 is provided as pixels 120, where pixels 120 are projected to provide an image to the eye of the user.

XR computing device 100 can include hardware components designed to enable immersive experiences. The hardware can include lenses or screens, often placed directly in front of the user's eyes in VR headsets or as transparent lenses in AR and MR devices. These displays can be coupled with sensors, such as accelerometers, gyroscopes, and magnetometers, which track head and body movements, allowing the device to adjust the virtual content accordingly. Cameras and depth sensors can also be used, especially in AR and MR devices, to capture the surrounding environment and integrate virtual objects into the real world. XR devices can also be configured with built-in speakers or spatial audio systems to provide immersive soundscapes.

Additionally, XR devices can include processors and graphic processing units (GPUs) to handle the real-time rendering of complex virtual environments and interactive elements. These processors enable the device to track user inputs, process visual and spatial data, and update the virtual content. Handheld controllers or hand-tracking sensors can be used for input, allowing users to interact with digital objects through natural movements. Some devices can also incorporate eye-tracking sensors to enhance precision and provide more intuitive control.

In the example of XR computing device 100, XR computing device 100 includes image source 110 and image source 111 to provide visual content for the user. Content is projected from image source 110 and image source 111 onto the lenses of XR computing device 100 through a combination of micro-displays and optical systems. The image sources 110-111, which can include OLED or LCD screens, generate the digital content. This image is then reflected or refracted through a series of optical elements, such as waveguides or lenses, to focus the content onto the user's field of view. In AR devices, transparent lenses allow the projection of virtual images while simultaneously letting the user see the real world. Waveguides distribute the light from the image source across the lens, merging digital content with real-world visuals, enabling an MR experience.

In at least one technical solution, at least one window is incorporated into the optical path of the images generated from image source 110 or image source 111. The at least one window is used to rectify alignment errors between image source 110 and image source 111. Windows can cause slight changes in the light's direction due to refraction, depending on the material and the angle of incidence. In at least one implementation, the at least one window is used to shift the pixels from at least one image source such that the pixels are aligned with the other image source. Pixel alignment refers to the precise positioning of display pixels to ensure a seamless and accurate visual experience without distortion or misalignment. Proper pixel alignment is required to maintain image clarity, reduce eye strain, and prevent visual artifacts in virtual, augmented, or mixed-reality environments.

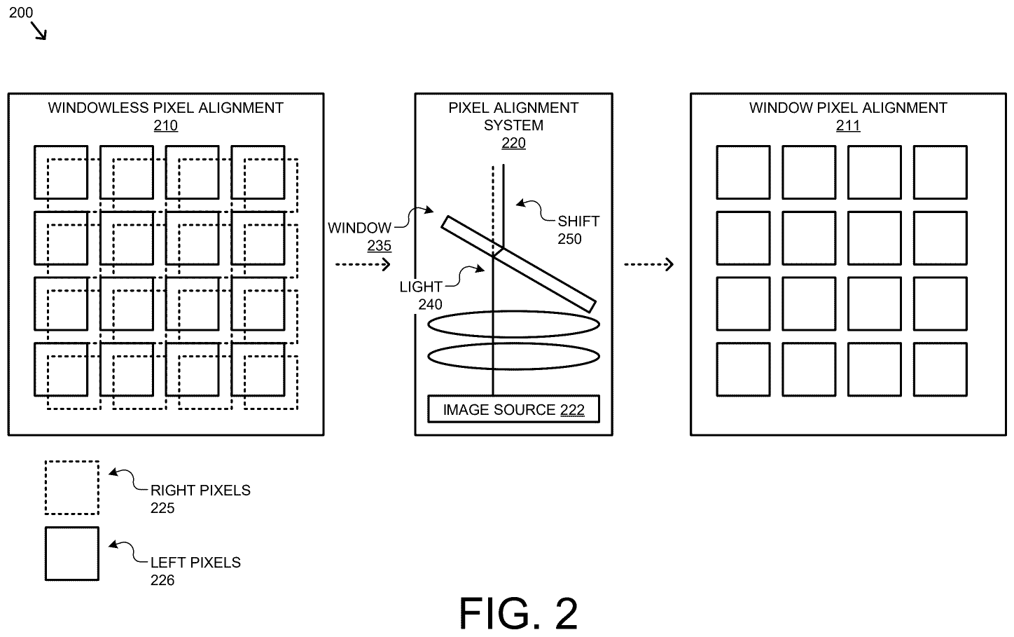

FIG. 2 illustrates an optical overview 200 for an XR computing device according to an implementation. Optical overview 200 includes windowless pixel alignment 210, pixel alignment system 220, and window pixel alignment 211. Pixel alignment system 220 includes image source 222, window 235, light 240, and shift 250. Shift 250 is representative of the light shift caused by window 235. Windowless pixel alignment 210 includes right pixels 225 and left pixels 226.

In optical overview 200, windowless pixel alignment 210 represents the alignment of the pixels from light sources associated with the right and left eyes. The pixels include right pixels 225 representative of the pixels for the right eye displayed for an XR device, and left pixels 226 representative of pixels for the left eye displayed for the XR device. In windowless pixel alignment 210, right pixels 225 and left pixels 226 are not aligned. Pixel alignment between the left and right eye on an XR device refers to synchronizing pixels displayed to each eye in stereoscopic vision to create a unified, three-dimensional visual experience. In XR devices like VR headsets, each eye receives slightly different images to simulate depth, and proper pixel alignment ensures that these images converge correctly in the brain, providing a coherent and comfortable perception of virtual objects. Misalignment between the left and right eye pixels can cause visual discomfort, eye strain, or a disorienting effect, detracting from the immersive experience and cause motion sickness.

For optical overview 200, pixel alignment system 220 is introduced to correct or shift the light from an image source 222. Although demonstrated using a single image source, windows can be introduced for the image sources for both the left and right eye to shift the light and align the pixels for the left and right eye. Here, in addition to the optical elements, such as lenses, waveguides, and image source 222, window 235 provides shift 250 for light 240. Window 235 shifts light by utilizing refraction, where the light changes direction as it passes through the material based on its refractive index and the angle of incidence. If the window is uniformly thick, the light can experience a slight shift while maintaining its overall direction. The system can shift light the requisite amount to support the alignment of the pixels. Referring to window pixel alignment 211 from pixel alignment system 220, the pixels are corrected or aligned from the version without the window. As at least one technical effect, the user experience is improved by limiting visual discomfort and eye strain.

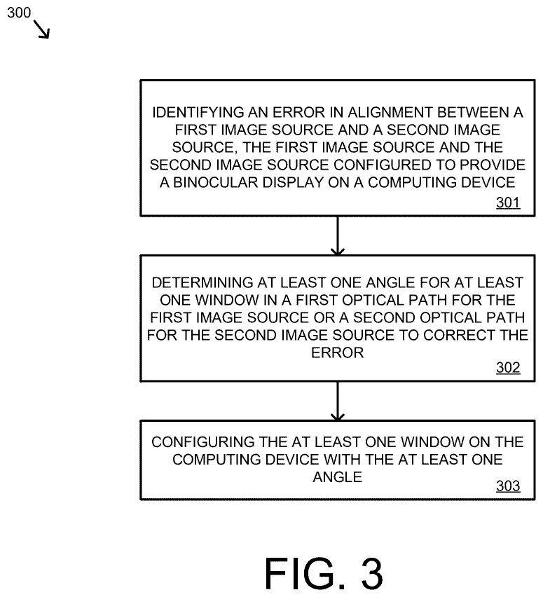

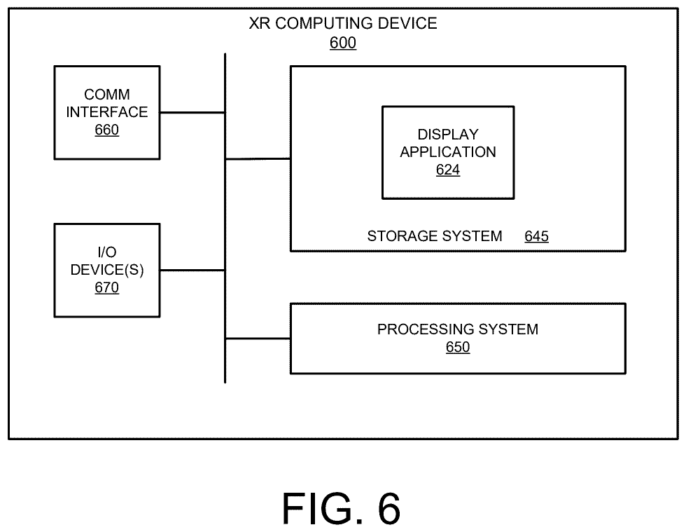

FIG. 3 illustrates method 300 of updating an optical configuration for a device according to an implementation. Method 300 is referenced parenthetically in the paragraphs that follow. Method 300 can be implemented on a computing device, such as an XR device or head-mounted device. Method 300 can also be implemented using one or more additional devices or systems, such as desktop computers, laptop computers, and the like. An example computing system that performs method 300 is XR computing device 600, as referenced in FIG. 6.

Method 300 includes identifying (301) an error in alignment between a first image source and a second image source, the first image source and the second image source configured to provide a binocular display on a computing device. In some implementations, the error comprises pixel alignment associated with the binocular display. Errors in pixel alignment on an XR display can occur when the pixels intended to create a seamless image are misaligned, resulting in visual artifacts such as blurriness, color fringing, or ghosting. These misalignments can arise from hardware issues, such as improper calibration of the display or inconsistent refresh rates, as well as software-related problems like rendering discrepancies. Such errors can degrade the user experience, causing discomfort and hindering immersion, particularly in applications that demand high precision, like gaming or simulation.

A device can be configured to measure pixel misalignment using calibrated imaging techniques and specialized algorithms to calculate the error. In one example, a computing device can project known patterns or test images onto the display and capture the output using high-resolution cameras positioned at the viewer's eye level. By analyzing the captured images, software can compare the intended pixel positions with the observed pixel locations to quantify misalignment. Techniques such as edge detection and pixel comparison can help identify discrepancies in alignment between the left and right displays. The device can use one or more cameras or other sensors to identify and measure the misalignment in pixels between the right and left eye projection.

Method 300 further includes determining (302) at least one angle for at least one window in a first optical path for the first image source or a second optical path for the second image source to correct the error. Method 300 also includes configuring (303) the at least one window on the computing device with the at least one angle. In some examples, the angle (and orientation for the angle) is determined based on the measured misalignment for the pixels. For instance, for a first misalignment measurement, a first angle is determined for the window. In contrast, for a second misalignment measurement or error, a second angle is determined for the window. As a technical effect, one or more angles for one or more windows can be updated to correct the error associated with the

In some implementations, the error correction can be performed on the optical path for a single image source (e.g., LCD or LED display). The correction in the single optical path can adjust the pixel vertically and horizontally to align the pixels for the left and right eye. In some implementations, the error correction can use a first window for the optical path associated with the right eye and a second window for the optical path associated with the left eye. The first window can be used to correct vertical alignment of the pixels, while the second window can be used to correct the horizontal alignment of the pixels.

Alternatively, the first window can be used to correct the horizonal alignment of the pixels, while the second window can be used to correct the vertical alignment. The technical effect is that a first window can correct a first axis (e.g., vertical), while the second window can correct a second axis (e.g., horizontal). This limits the actuators or other rotational elements required for each window. While increasing the number of windows on the device, the actuators and rotational elements for each window are reduced.

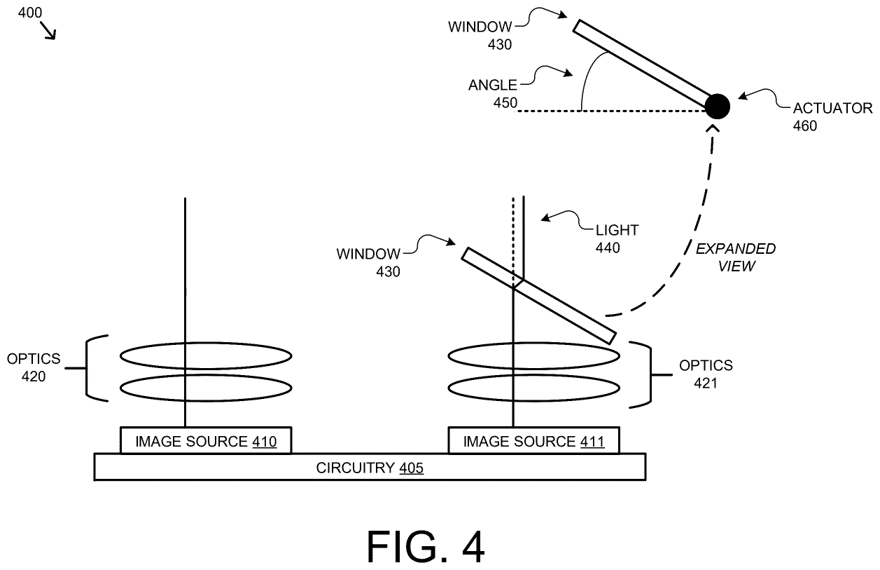

FIG. 4 illustrates an optical configuration 400 for an XR computing device according to an implementation. Optical configuration 400 includes circuitry 405, image source 410, image source 411, optics 420, optics 421, window 430, and light 440. Image sources 410-411 can include LCDs, OLEDs, or some other display technology that generates images for both the right and left eyes of the user. In the optical path from image sources 410-411 are optics 420-421. Optics 420-421 can include aspheric lenses, Fresnel lenses, hybrid lenses, or other lenses to magnify and warp the display, allowing users to see a large field of view without distortion. These lenses can focus the images on screens very close to the eyes, creating the illusion of depth and distance. In AR devices, waveguides, diffraction optics, or reflective optics can overlay digital content onto the real-world view. These optics guide light through transparent materials to project images directly into the user's eyes while still allowing them to see the physical environment.

In addition to optics 421, light 440 from image source 411 passes through window 430. A window 430 set at an angle 450 can shift light 440 by refracting and reflecting it, causing the light to change direction as it passes through the glass. The refraction alters the light's path, depending on the angle of incidence and the properties of the glass. In some implementations, window 430 can represent borosilicate crown glass. In some implementations, window 430 represents an N-BK7, which is an example of the borosilicate crown glass. In some implementations, window 430 represents an achromatic window made of a combination of glasses. The achromatic window can be used to prevent the separation of colors in some examples. An achromatic window prevents light from separating into different colors using materials or coatings that correct for chromatic aberration. This ensures that all wavelengths of light pass through the window without dispersion, keeping the light focused and maintaining its original color composition.

In some examples, angle 450 is dictated by testing image sources 410-411 and optics 420-421 without the use of window 430. Alignment in a binocular display for an XR device can be tested by ensuring that the images presented to each eye are properly coordinated to create a seamless and accurate three-dimensional effect. This can involve checking the convergence and divergence of the lenses, the synchronization of virtual objects in both displays, and the optical calibration to prevent misalignment, which could cause eye strain or distortions. Testing can include hardware calibration, using specialized equipment to measure inter-pupillary distance (IPD) and ensure the lenses are correctly positioned, and software alignment, where test patterns or virtual environments are used to verify that the visual content is consistently rendered in both displays. From the testing, measurements can be taken in association with the distortion or alignment of the pixels from image sources 410-411. The measurements are then used to determine angle 450. In some implementations, the pixel alignment is measured using cameras and/or other sensors that determine the direction and distance the pixels misaligned.

In some implementations, angle 450 for window 430 is configured by at least one actuator, such as actuator 460. An actuator is a mechanical device that converts energy into motion, enabling the controlled movement of window 430. Actuator 460 can move window 430 by pushing, pulling, or rotating it with precision. The actuator can be controlled by one or more processors or control systems that configure the window to provide the desired angle to overcome the misalignment between the different image sources. The one or more processors can be located on the XR device or separate from the XR device in some examples. In some implementations, rather than using an actuator, window 430 can be manually configured at angle 450, wherein the angle is established by rotating the window around an axis to the requested angle. The angle corrects the misalignment of the pixels from image source 410 and image source 411.

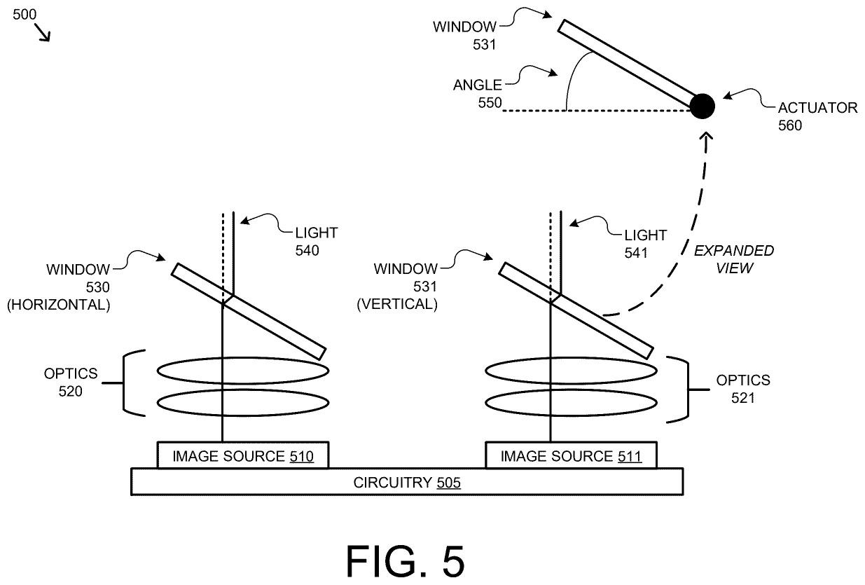

FIG. 5 illustrates an optical configuration 500 for an XR computing device according to an implementation. Optical configuration 500 includes circuitry 505, image source 510, images source 511, optics 520, optics 521, window 530, and light 540. Image sources 510-511 can include LCDs, OLEDs, or some other display technology that generates images for both the right and left eyes of the user. In the optical path from image sources 510-511 are optics 520-521. Optics 520-521 can include aspheric lenses, Fresnel lenses, hybrid lenses, or other lenses to magnify and warp the display, allowing users to see a large field of view without distortion. These lenses can focus the images on screens very close to the eyes, creating the illusion of depth and distance. In AR devices, waveguides, diffraction optics, or reflective optics can overlay digital content onto the real-world view. These optics guide light through transparent materials to project images directly into the user's eyes while still allowing them to see the physical environment.

In addition to optics 520, light 540 from image source 510 passes through window 530, which corrects a first portion of the pixel alignment (e.g., horizontal alignment of the pixels). Further, in addition to optics 521, light 541 from image source 511 passes through window 531, which corrects a second portion of the pixel alignment (e.g., vertical alignment of the pixels). Although demonstrated as correcting the vertical and horizontal alignment, the windows can support different orientations. The effect on different orientations can permit a first window to fix a first portion of the alignment error while a second window corrects a second portion.

A window set at an angle can shift light by refracting and reflecting it, causing the light to change direction as it passes through the glass. The refraction alters the light's path, depending on the angle of incidence and the properties of the glass. An example window is demonstrated for window 530, wherein angle 550 changes the shift associated with light 541. A similar configuration can also be applied with window 530 for image source 510. In some implementations, windows 530-531 can represent borosilicate crown glass. In some implementations, windows 530-531 represent N-BK7 windows, an example of borosilicate crown glass. In some implementations, windows 530-531 represent achromatic windows made of a combination of glasses. An achromatic window prevents light from separating into different colors using materials or coatings that correct for chromatic aberration. This ensures that all wavelengths of light pass through the window without dispersion, keeping the light focused and maintaining its original color composition.

In some examples, angle 550 (and the angle of window 530) is dictated by testing image sources 510-511 and optics 520-521 without the use of the windows. Alignment in a binocular display for an XR device can be tested by checking the convergence and divergence of the lenses, the synchronization of virtual objects in both displays, and the optical calibration to prevent misalignment, which could cause eye strain or distortions. Testing can include hardware calibration, using specialized equipment to measure inter-pupillary distance (IPD) and ensure the lenses are correctly positioned, and software alignment, where test patterns or virtual environments are used to verify that the visual content is consistently rendered in both displays. From the testing, measurements can be taken in association with the distortion or alignment of the pixels from image sources 510-511. The measurements are then used to determine angles associated with window 530 and window 531.

In some implementations, angle 550 for window 531 is configured by at least one actuator, such as actuator 560. An actuator is a mechanical device that converts energy into motion, enabling the controlled movement of window 531. Actuator 560 can precisely move window 531 by pushing, pulling, or rotating it. The actuator can be controlled by one or more processors or control systems that configure the window to provide the desired angle to overcome the misalignment between the different image sources. The one or more processors can be located on the XR device or separate from the XR device. In some implementations, rather than using an actuator, window 531 can be manually configured at angle 550. Using one or more mechanical elements, a system can rotate the window around the axis to place window 531 at angle 550. Similar operations can also be performed for window 530. The angles correct the misalignment of the pixels from image source 510 and image source 511. In some examples, the angles can be used to correct different axis (e.g., horizontal and vertical). For example, window 530 can be used to correct the pixel misalignment in a first axis (e.g., vertical) and window 531 can be used to correct the pixel misalignment in a second axis (e.g., horizontal). The combination of the windows can align the pixels from image sources 510-511.

FIG. 6 illustrates an XR computing device 600 according to an implementation. XR computing device 600 can represent any computing system or systems with which the various operational architectures, processes, scenarios, and sequences disclosed herein for an XR computing device may be implemented. XR computing device 600 is an example of XR computing device 100 of FIG. 1. XR computing device 600 includes storage system 645, processing system 650, communication interface 660, input/output (I/O) device(s) 670. Processing system 650 is operatively linked to communication interface 660, I/O device(s) 670, and storage system 645. In some implementations, communication interface 660 and/or I/O device(s) 670 may be communicatively linked to storage system 645. XR computing device 600 may further include other components such as a battery and enclosure that are not shown for clarity.

Communication interface 660 comprises components that communicate over communication links, such as network cards, ports, radio frequency, processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format-including combinations thereof. Communication interface 660 may be configured to communicate with external devices, such as servers, user devices, or other computing devices.

I/O device(s) 670 may include computer peripherals that facilitate the interaction between the user and XR computing device 600. Examples of I/O device(s) 670 may include keyboards, mice, trackpads, monitors, displays, printers, cameras, microphones, external storage devices, and the like. In some implementations, I/O device(s) 670 include display systems and processors to provide a user with a binocular display.

Processing system 650 comprises microprocessor circuitry (e.g., at least one processor) and other circuitry that retrieves and executes operating software (i.e., program instructions) from storage system 645. Storage system 645 may include volatile and nonvolatile, removable, and non-removable media implemented in any method or technology for storage of information, such as computer-readable instructions, data structures, program modules, or other data. Storage system 645 may be implemented as a single storage device and across multiple storage devices or sub-systems. Storage system 645 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be a non-transitory storage media. In some instances, at least a portion of the storage media may be transitory. In no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises display application 624. The operating software on storage system 645 may further include an operating system, utilities, drivers, network interfaces, applications, or some other type of software. When read and executed by processing system 650 the operating software on storage system 645 directs XR computing device 600 to operate as a computing device as described herein. In at least one implementation, the operating software can provide at least method 300 of FIG. 3.

In at least one implementation, display application 624 directs processing system 650 to an error in alignment between a first image source and a second image source, the first image source and second image source configured to provide a binocular display on a computing device. In some implementations, the error comprises pixel alignment associated with the binocular display. Errors in pixel alignment on an XR display can occur when the pixels intended to create a seamless image are misaligned, resulting in visual artifacts such as blurriness, color fringing, or ghosting. These misalignments can arise from hardware issues, such as improper calibration of the display or inconsistent refresh rates, as well as software-related problems like rendering discrepancies. Such errors can degrade the user experience, causing discomfort and hindering immersion, particularly in applications that demand high precision, like gaming or simulation. To measure the error, display application 624 can direct processing system 650 to measure pixel misalignment by utilizing calibrated imaging techniques and specialized algorithms. In one example, display application 624 project known patterns or test images onto the display and capture the output using high-resolution cameras positioned at the viewer's eye level. By analyzing the captured images, software can compare the intended pixel positions with the observed pixel locations to quantify misalignment. Techniques such as edge detection and pixel comparison can help identify discrepancies in alignment between the left and right displays. Although demonstrated as being performed on the device, error detection can use one or more other computer in addition to or in place of the XR device. The one or more additional computers can use cameras or other sensors to detect the error in alignment for the XR device display.

Display application 624 further directs processing system 650 to determine at least one angle for at least one window in a first optical path for the first image source or a second optical path for the second image source to correct the error. Display application 624 further directs processing system 650 to configure the at least one window on the computing device with the at least one angle.

In some implementations, the error correction can be performed on the optical path for a single image source (e.g., LCD or LED display). The correction in the single optical path can adjust the pixel vertically and horizontally to align the pixels for the left and right eye. In some implementations, the error correction can use a first window for the optical path associated with the right eye and a second window for the optical path associated with the left eye. The first window can be used to correct vertical alignment of the pixels, while the second window can be used to correct the horizontal alignment of the pixels. Alternatively, the first window can be used to correct the horizonal alignment of the pixels, while the second window can be used to correct the vertical alignment. The technical effect is that a first window can correct a first orientation (e.g., vertical), while the second window can correct a second orientation (e.g., horizontal). This limits the actuators or other rotational elements required for each of the windows. While increasing the number of windows, the actuators and rotational elements for each of the windows is reduced.

In some implementations, XR computing device can include at least one actuator to configure the angle associated with the window. The actuator can tilt or rotate the window to provide the desired angle or shift of the pixels. In some implementations, the actuator (or other rotational equipment) can place the glass in the appropriate angle to shift the pixels.

Although demonstrated as being performed on the XR device, one or more other computing devices or system can store and execute the program instructions described herein to perform the pixel alignment for XR computing device 600.

Clause 1. A system comprising: a first image source for a left eye; a second image source for a right eye; and at least one window in a first optical path for the first image source or a second optical path for the second image source, the at least one window configured to align first pixels from the first image source with second pixels from the second image source as part of a binocular display.

Clause 2. The system of clause 1, wherein the at least one window is configured at an angle relative to the first optical path or the second optical path.

Clause 3. The system of clause 1, wherein the at least one window comprises at least one first window in the first optical path for the first image source and at least one second window in the second optical path for the second image source.

Clause 4. The system of clause 3, wherein the at least one first window is configured at a first angle relative to the first optical path and wherein the at least one second window is configured at a second angle relative to the second optical path.

Clause 5. The system of clause 1, wherein the at least one window comprises a first window and a second window, wherein the first window aligns the first pixels with the second pixels horizontally, and wherein the second window aligns the first pixels with the second pixels vertically.

Clause 6. The system of clause 1, wherein the at least one window comprises borosilicate crown glass.

Clause 7. The system of clause 1, wherein the first image source comprises a first light emitting diode panel, and wherein the second image source comprises a second light emitting diode panel.

Clause 8. The system of clause 1 further comprising: at least one processor operatively coupled to the first image source and the second image source.

Clause 9. The system of clause 1 further comprising: a first lens in the first optical path; and a second lens in the second optical path.

Clause 10. The system of clause 1, wherein the system comprises a head-mounted device.

Clause 11. A method comprising: identifying an error in alignment between a first image source and a second image source, the first image source and the second image source configured to provide a binocular display on a computing device; determining at least one angle for at least one window in a first optical path for the first image source or a second optical path for the second image source to correct the error; and configuring the at least one window on the computing device with the at least one angle.

Clause 12. The method of clause 11, wherein the error comprises pixel alignment.

Clause 13. The method of clause 11, wherein the at least one window comprises a first window and a second window, and wherein determining the at least one angle for the at least one window in the first optical path for the first image source or the second optical path for the second image source comprises: determining a first angle for the first window in the first optical path and a second angle for the second window in the second optical path.

Clause 14. The method of clause 13, wherein the error comprises a vertical error and a horizontal error, wherein the first angle corrects the vertical error, and wherein the second angle corrects the horizontal error.

Clause 15. The method of clause 11, wherein at least one window comprises borosilicate crown glass.

Clause 16. The method of clause 11, wherein the first image source comprises a first light emitting diode panel, and wherein the second image source comprises a second light emitting diode panel.

Clause 17. The method of clause 11, wherein configuring the at least one window on the computing device with the at least one angle comprises causing an actuator to move the at least one window to the at least one angle.

Clause 18. A computer-readable storage medium having program instructions stored thereon that, when executed by at least one processor, direct the at least one processor to perform a method, the method comprising: identifying an error in alignment between a first image source and a second image source, the first image source and second image source configured to provide a binocular display on a computing device; determining at least one angle for at least one window in a first optical path for the first image source or a second optical path for the second image source to correct the error; and configuring the at least one window on the computing device with the at least one angle.

Clause 19. The computer-readable storage medium of clause 18, wherein the at least one window comprises a first window and a second window, and wherein determining the at least one angle for the at least one window in the first optical path for the first image source or the second optical path for the second image source comprises: determining a first angle for the first window in the first optical path and a second angle for the second window in the second optical path.

Clause 20. The computer-readable storage medium of clause 18, wherein configuring the at least one window on the computing device with the at least one angle comprises causing an actuator to move the at least one window to the at least one angle.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing aspects and is not intended to be limiting. On the contrary, this patent covers all methods, apparatus and articles of manufacture fairly falling within the scope of the claims of this patent.

What is claimed is:

1. A system comprising:
a first image source for a left eye;
a second image source for a right eye; and
at least one window in a first optical path for the first image source or a second optical path for the second image source, the at least one window configured to align first pixels from the first image source with second pixels from the second image source as part of a binocular display.

2. The system of claim 1, wherein the at least one window is configured at an angle relative to the first optical path or the second optical path.

3. The system of claim 1, wherein the at least one window comprises at least one first window in the first optical path for the first image source and at least one second window in the second optical path for the second image source.

4. The system of claim 3, wherein the at least one first window is configured at a first angle relative to the first optical path and wherein the at least one second window is configured at a second angle relative to the second optical path.

5. The system of claim 1, wherein the at least one window comprises a first window and a second window, wherein the first window aligns the first pixels with the second pixels horizontally, and wherein the second window aligns the first pixels with the second pixels vertically.

6. The system of claim 1, wherein the at least one window comprises borosilicate crown glass.

7. The system of claim 1, wherein the first image source comprises a first light emitting diode panel, and wherein the second image source comprises a second light emitting diode panel.

8. The system of claim 1 further comprising:
at least one processor operatively coupled to the first image source and the second image source.

9. The system of claim 1 further comprising:
a first lens in the first optical path; and
a second lens in the second optical path.

10. The system of claim 1, wherein the system comprises a head-mounted device.

11. A method comprising:
identifying an error in alignment between a first image source and a second image source, the first image source and the second image source configured to provide a binocular display on a computing device;
determining at least one angle for at least one window in a first optical path for the first image source or a second optical path for the second image source to correct the error; and
configuring the at least one window on the computing device with the at least one angle.

12. The method of claim 11, wherein the error comprises pixel alignment.

13. The method of claim 11, wherein the at least one window comprises a first window and a second window, and wherein determining the at least one angle for the at least one window in the first optical path for the first image source or the second optical path for the second image source comprises:
determining a first angle for the first window in the first optical path and a second angle for the second window in the second optical path.

14. The method of claim 13, wherein the error comprises a vertical error and a horizontal error, wherein the first angle corrects the vertical error, and wherein the second angle corrects the horizontal error.

15. The method of claim 11, wherein at least one window comprises borosilicate crown glass.

16. The method of claim 11, wherein the first image source comprises a first light emitting diode panel, and wherein the second image source comprises a second light emitting diode panel.

17. The method of claim 11, wherein configuring the at least one window on the computing device with the at least one angle comprises causing an actuator to move the at least one window to the at least one angle.

18. A computer-readable storage medium having program instructions stored thereon that, when executed by at least one processor, direct the at least one processor to perform a method, the method comprising:
identifying an error in alignment between a first image source and a second image source, the first image source and second image source configured to provide a binocular display on a computing device;
determining at least one angle for at least one window in a first optical path for the first image source or a second optical path for the second image source to correct the error; and
configuring the at least one window on the computing device with the at least one angle.

19. The computer-readable storage medium of claim 18, wherein the at least one window comprises a first window and a second window, and wherein determining the at least one angle for the at least one window in the first optical path for the first image source or the second optical path for the second image source comprises:
determining a first angle for the first window in the first optical path and a second angle for the second window in the second optical path.

20. The computer-readable storage medium of claim 18, wherein configuring the at least one window on the computing device with the at least one angle comprises causing an actuator to move the at least one window to the at least one angle.
